(19) United States
(12) Patent Application Publication
(10) Pub. No.: US 2007/0031100 A1
(43) Pub. Date: Feb. 8, 2007

(54) Optical fiber distribution cabinet

(76) Inventors: Cesar G. Garcia, N. Richland Hills, TX (US); Todd E. Mitchell, Ft. Worth, TX (US); Harini Varadarajan, Ft. Worth, TX (US); William J.M. Giraud, Springtown, TX (US)

Correspondence Address: CORNING CABLE SYSTEMS LLC, P O BOX 489, HICKORY, NC, 28603, US

(21) Appl. No.: 11/197,213

(22) Filed: Aug. 4, 2005

(51) Int. Cl. G02B 6/00

(52) U.S. Cl. 385/135

(57) ABSTRACT

An optical fiber distribution cabinet includes at least three separate, vertically arranged areas of optical fiber functionality; namely a coupler module storage compartment, a fiber slack storage compartment, and a fiber connection compartment with the fiber slack storage compartment disposed laterally between the coupler module storage compartment and the fiber connection compartment. A plurality of pre-connectorized (pigtail or jumper) coupler module output fibers are routed from the coupler module storage compartment through the fiber slack storage compartment to the fiber connection compartment and interconnected with corresponding optical fibers of one or more pre-connectorized distribution cables. At least one coupler module input fiber is spliced directly to an optical fiber of a feeder cable. Alternatively, the coupler module input fiber is routed from the coupler module storage compartment through the fiber slack storage compartment to the fiber connection compartment and interconnected with a corresponding optical fiber of a pre-connectorized feeder cable.

### BACKGROUND OF THE INVENTION

1. Field of the Invention

The present invention relates generally to an optical fiber distribution cabinet for use in a passive optical network (PON), and more particularly, to an optical fiber distribution cabinet for interconnecting optical fibers of a feeder cable with optical fibers of one or more distribution cables in the outside plant of a PON.

2. Technical Background

It is now well known to use an optical splitter (referred to herein as a coupler module) in the outside plant of a passive optical network (PON) to distribute a broadband optical communications signal from a service provider to multiple subscribers. In a typical PON, an optical fiber distribution cabinet, sometimes referred to in the art as a fiber distribution hub (FDH) or a fiber distribution terminal (FDT), is positioned at a convenient location along a primary feeder cable to split the optical signal carried on an optical fiber of the feeder cable into multiple optical signals carried on a corresponding plurality of optical fibers of one or more distribution cables. An outdoor cabinet for interconnecting an optical fiber of a feeder cable with at least two optical fibers of a distribution cable at a local convergence point beyond the central office in an optical network is shown and described in U.S. Pat. No. 6,792,191 assigned to Corning Cable Systems LLC of Hickory, N.C. The feeder cable and the distribution cable are first routed inside the cabinet and optical fibers of the feeder cable and the distribution cable are then spliced to a relatively short length of optical fiber having a connectorized end, referred to in the art as a “pigtail.” Each feeder cable pigtail is then routed to an input fiber adapter provided on a coupler module mounted within the cabinet. Likewise, certain of the distribution cable pigtails are routed to output fiber adapters provided on the coupler module. In this manner, the optical signal carried on an optical fiber of the feeder cable is split (e.g., divided) into multiple optical signals carried on different optical fibers of the distribution cable. In one particular example, 18 optical fibers of a feeder cable are each split into 16 optical fibers of a distribution cable utilizing 1×16 coupler modules. In another particular example, 9 optical fibers are each split into 32 optical fibers of a distribution cable utilizing 1×32 coupler modules. In either case, the corresponding optical fiber distribution cabinet is referred to a “288-fiber Capacity Fiber Distribution Hub (FDH)” because the optical connections between the feeder cable and the distribution cable(s) result in a maximum of 288 distribution cable optical fibers. While a 288-fiber Capacity FDH is common, a cabinet resulting in any convenient number of distribution cable optical fibers is also possible, including for example, 144, 432, 576, etc.

In many instances, the optical fiber distribution cabinet functions as an interface between the service provider's optical network (e.g., the PON) and the individual subscriber connections. The cabinet provides mechanical and environmental protection for the optical fiber splices and the fiber optic connector interfaces inside the cabinet, with convenient access for the service provider to the connections. In addition, the cabinet provides an organized routing and management system for the optical fiber, fiber optic connectors and coupler modules, as well as a test access location to verify the integrity of the optical network. While existing cabinets (including the local convergence cabinet described in U.S. Pat. No. 6,792,191) satisfy most of the above objectives, all function less than optimally in one or more of the desired objects. In particular, none of the existing cabinets provides full and complete functionality for one or more pre-connectorized distribution cables in a compact enclosure with easy and ready access to the optical connections between the optical fibers of the distribution cables and the coupler module output fibers. What is needed is an optical fiber distribution cabinet configured to receive one or more pre-connectorized distribution cables that provides easy fiber management, convenient fiber slack storage, bend radius control and ready connector access in a clean, compact enclosure that facilitates handling, installation, initial configuration, reconfiguration and testing, and which is scalable to accommodate any desired number of feeder cable and distribution cable optical fibers. As will be described in further detail hereinafter, the present invention provides these and other features and advantages, and thereby satisfies the heretofore unresolved need for an optimal optical fiber distribution cabinet.

### SUMMARY OF THE INVENTION

In one aspect, the present invention provides an optical fiber distribution cabinet including an enclosure defining an interior. The interior of the distribution cabinet is separated into at least three vertically arranged and laterally disposed compartments. The first compartment includes at least one coupler module for splitting at least one input optical signal into a plurality of output optical signals. The second compartment is disposed laterally adjacent the first compartment and includes at least one fiber slack storage hub. The third compartment is disposed laterally adjacent the second compartment and includes a fiber connection field. At least one optical fiber cable extends between the coupler module within the first compartment and the fiber connection field within the third compartment.

The distribution cabinet may further include a fiber splicing area disposed vertically beneath at least the third compartment for splicing an optical fiber of a feeder cable to an input fiber of the coupler module. Furthermore, the fiber connection field may include an input fiber termination field and an output fiber termination field disposed vertically above the input fiber termination field. The third compartment may further include a connector storage area disposed between the input fiber termination field and the output fiber termination field or disposed vertically beneath input fiber termination field.

In one embodiment, the optical fiber cable is a pigtail including a first end in optical communication with the coupler module and a second end having a fiber optic connector mounted thereon. The pigtail is routed from the coupler module to a connector adapter disposed on the fiber connection field. In another embodiment, the optical fiber cable is a jumper including a first end having a first fiber optic connector mounted thereon and a second end having a second fiber optic connector mounted thereon. The coupler module has a first connector adapter disposed thereon for receiving the first fiber optic connector and the fiber connection field has a second connector adapter disposed thereon for receiving the second fiber optic connector. The jumper is routed from the first connector adapter disposed on the coupler module to the second connector adapter disposed on the fiber connection field.

In yet another aspect, the present invention provides an optical fiber distribution cabinet for interconnecting an optical fiber of a feeder cable with a plurality of optical fibers of at least one distribution cable. The distribution cabinet includes an enclosure defining an interior separated into at least three vertically arranged and laterally disposed compartments. A coupler module storage compartment vertically arranged within the interior includes at least one coupler module for splitting an optical signal carried on the optical fiber of the feeder cable into a plurality of optical signals carried on the optical fibers of the distribution cable. A fiber slack storage compartment vertically arranged within the interior and disposed laterally adjacent the coupler module storage compartment includes at least one fiber slack storage hub. A fiber connection compartment vertically arranged within the interior and disposed laterally adjacent the fiber slack storage compartment includes a fiber connection field. At least one optical fiber cable extends between the coupler module and the fiber connection field through the fiber slack storage compartment and a slack length of the optical fiber cable is retained on the fiber slack storage hub. The fiber connection field may include a feeder termination field and a distribution termination field disposed vertically above the feeder termination field. Furthermore, the fiber connection compartment may further include a connector storage field disposed vertically beneath the fiber connection field. The distribution cabinet may further include a fiber splicing area disposed vertically beneath at least the fiber connection compartment for splicing the optical fiber of the feeder cable to an input fiber of the coupler module.

In one embodiment, the optical fiber cable is a pigtail including a first end in optical communication with the coupler module and a second end having a fiber optic connector mounted thereon wherein the pigtail is routed from the coupler module to a connector adapter disposed on the fiber connection field. In another embodiment, the optical fiber cable is a jumper including a first end having a first fiber optic connector mounted thereon and a second end having a second fiber optic connector mounted thereon. The coupler module has a first connector adapter disposed thereon for receiving the first fiber optic connector and the fiber connection field has a second connector adapter disposed thereon for receiving the second fiber optic connector. The jumper is routed from the first connector adapter disposed on the coupler module to the second connector adapter disposed on the fiber connection field.

Additional features and advantages of the invention are set forth in the detailed description which follows and will be readily apparent to those skilled in the art from that description, or will be readily recognized by practicing the invention as described in the detailed description, including the claims, and the appended drawings. It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this written specification. The drawings illustrate various exemplary embodiments of the invention, and together with the detailed description, serve to explain the principles and operations thereof. Additionally, the drawings and descriptions are intended to be merely illustrative of possible embodiments of the invention, and not to limit the scope of the appended claims in any manner.

### BRIEF DESCRIPTION OF THE DRAWINGS

FIG. 1 is a front elevation view of an exemplary embodiment of an optical fiber distribution cabinet arranged and configured in accordance with the present invention and shown with the openable front door removed for purposes of clarity.

FIG. 2 is a rear perspective view of the optical fiber distribution cabinet of FIG. 1 shown with an exemplary maintenance panel removed for purposes of clarity;

FIG. 3A is a front perspective view of one side of the optical fiber distribution cabinet of FIG. 1 taken in the direction indicated therein showing the coupler module storage compartment and the fiber slack storage compartment in greater detail.

FIG. 3B is a front perspective view of the other side of the optical fiber distribution cabinet of FIG. 1 taken in the direction indicated therein showing the fiber connection compartment and the fiber slack storage compartment in greater detail.

FIG. 4 is an enlarged perspective view of a typical 1×32 coupler module for mounting in the coupler module storage compartment of an optical fiber distribution cabinet according to the present invention.

FIG. 5 is an enlarged front perspective view of the lower portion of the optical fiber distribution cabinet of FIG. 1 showing the fiber splicing area in greater detail.

FIG. 6 is a front elevation view of another exemplary embodiment of an optical fiber distribution cabinet arranged and configured in accordance with the present invention and shown with the openable front doors removed for purposes of clarity.

### DETAILED DESCRIPTION OF PREFERRED EMBODIMENTS OF THE INVENTION

Reference will now be made in detail to exemplary and presently preferred embodiments of the invention, illustrations of which are provided in the accompanying drawings. Whenever possible, the same reference numerals are used throughout the drawings to refer to the same or similar parts. The present invention is an optical fiber distribution cabinet, sometimes referred to in the art as a fiber distribution hub (FDH) or a fiber distribution terminal (FDT), for use in the outside plant of a passive optical network (PON) as an interface between a provider of broadband optical communications services and multiple subscribers. The optical fiber distribution cabinet is operable for splitting an input optical signal carried on an optical fiber of a feeder cable into multiple output optical signals carried on corresponding optical fibers of one or more distribution cables, and for interconnecting the optical fiber of the feeder cable with the corresponding optical fibers of the distribution cable(s). As will be described in further detail hereinafter, an optical fiber distribution cabinet according to the present invention is configured to receive one or more pre-connectorized distribution cables and provides easy fiber management, convenient fiber slack storage, bend radius control and ready connector access in a clean, compact enclosure that facilitates handling, installation, initial configuration, reconfiguration and testing. Furthermore, the optical fiber distribution cabinet is scalable to accommodate any desired number of feeder cable optical fibers and distribution cable optical fibers, for example 144, 288, 432, 576, etc.

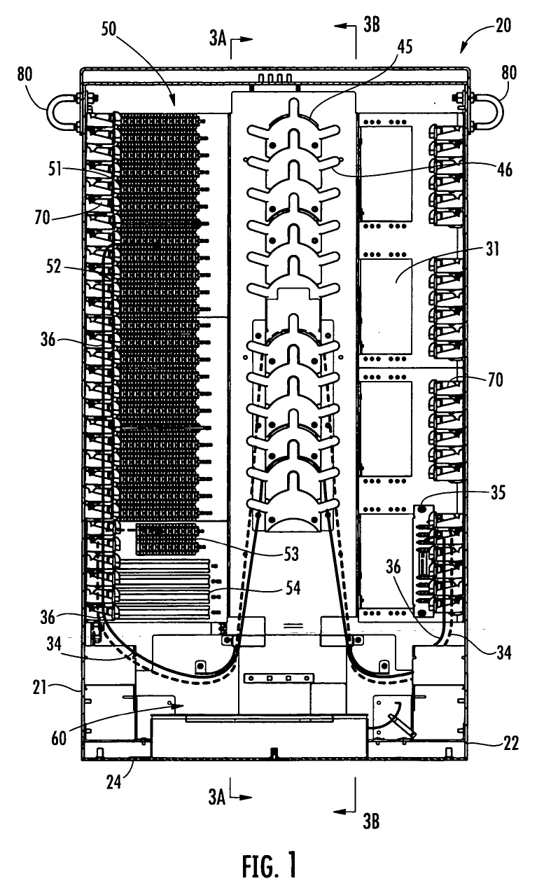

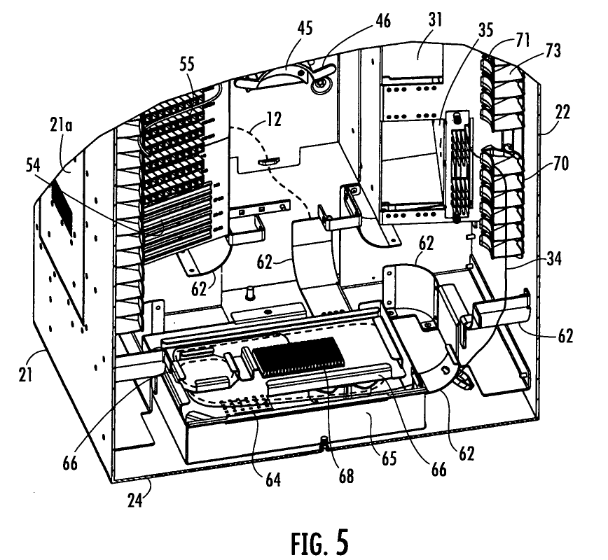

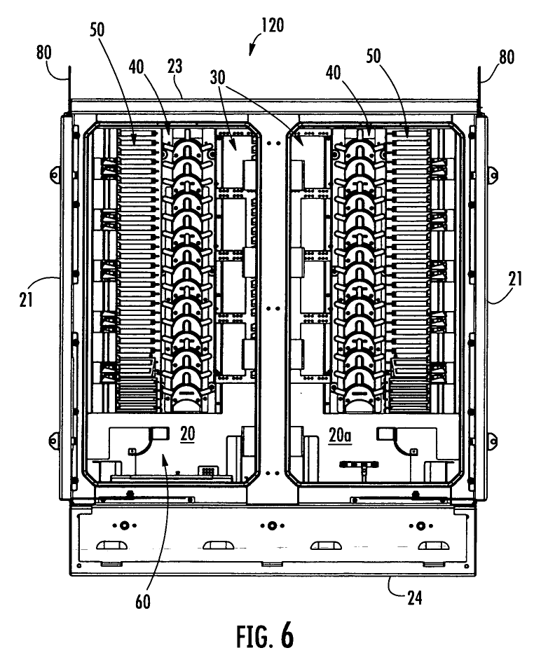

Referring now to the accompanying drawings, in one aspect the present invention is an optical fiber distribution cabinet for splitting an input optical signal carried on an optical fiber of a feeder cable into a plurality of output optical signals carried on optical fibers of one or more distribution cables, and for interconnecting the optical fiber of the feeder cable with the corresponding plurality of optical fibers of the distribution cable(s). As shown and described herein, a distribution cabinet 20 defines an enclosure comprising three separate, vertically arranged areas of optical fiber functionality; namely coupling (splitting), slack storage, and interconnecting (connection). Specifically, the distribution cabinet 20 comprises a coupler module storage compartment 30, a fiber slack storage compartment 40, and a fiber connection compartment 50. Each functional compartment 30, 40, 50 is arranged vertically within the interior of the distribution cabinet 20 defined by the enclosure with the fiber slack storage compartment 40 disposed laterally between the coupler module storage compartment 30 and the fiber connection compartment 50. As shown, the coupler module storage compartment 30 is disposed along the right-hand side of the distribution cabinet 20 and the fiber connection compartment 50 is disposed along the left-hand side of the cabinet. However, the position of the compartment 30 and the position of the compartment 50 may be reversed, as will be described hereinafter with reference to FIG. 6. Furthermore, the position of the fiber slack storage compartment 40 may be interchanged as desired with the position of the coupler module storage compartment 30 or the position of the fiber connection compartment 50. Regardless, the configuration shown and described herein with reference to FIG. 1-5 is preferred since the location of the compartment 40 relative to the compartment 30 and the compartment 50 optimizes fiber management and provides substantially unrestricted access to both the coupler modules 35 mounted in the coupler module storage compartment 30 and the connector adapters 55 mounted in the fiber connection compartment 50, as will be described. In the exemplary embodiments shown and described herein, the distribution cabinet 20 further comprises a fiber splicing area 60 for a purpose to be described. However, as will be explained, the fiber splicing area 60 is optional and may be omitted in the event that both the feeder cable and the distribution cable(s) are pre-connectorized. The enclosure of the distribution cabinet 20 generally includes a pair of opposed side panels 21, 22, a top panel 23, a bottom panel 24, a rear panel 25 and an openable front door (not shown for purposes of clarity) opposite the rear panel, which together define the interior of the distribution cabinet. All or a portion of the rear panel 25 and at least one of the side panels 21, 22 may be openable or removable to provide improved access to the rear and side portions of the distribution cabinet 20 for assembly, installation and service. For example, a maintenance panel 21a may be provided in a portion of the side panel 21 as illustrated in FIG. 5 to provide access t the rear of the fiber connection compartment 50 for purposes to be described. Once assembled and installed, a field technician from the communications service provider typically need only access the front portion of the distribution cabinet 20 (i.e., splice drawer, coupler modules, fiber routing guides, fiber routing hubs, fiber slack storage hubs, termination fields, connector storage (parking) field, etc.) for the purposes described hereinafter.

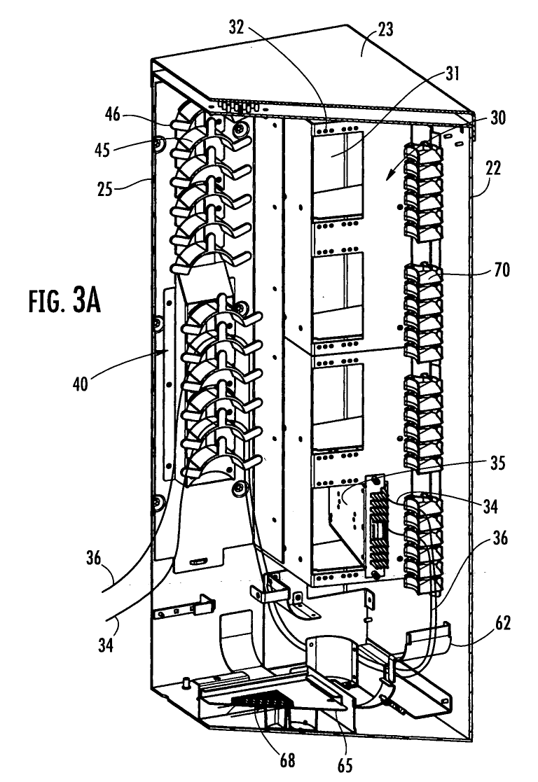

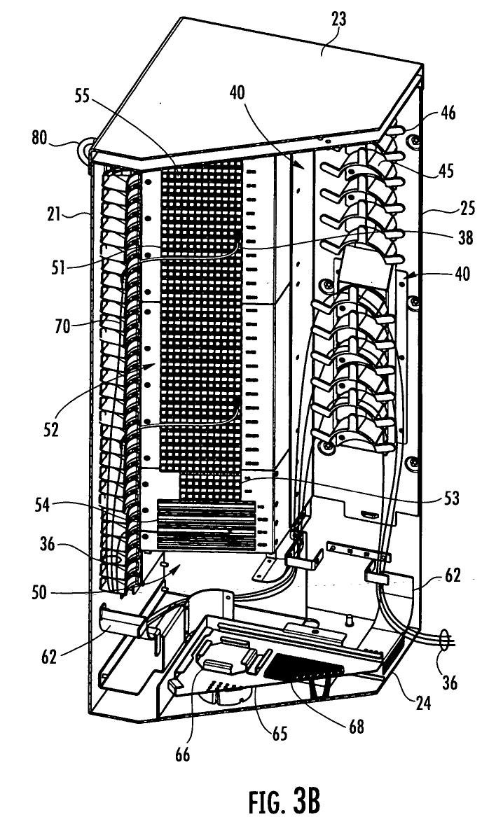

As best shown in FIGS. 1, 2, 3A, and 3B, the side panels 21, 22, top panel 23, bottom panel 24 and rear panel 25 define an interior within the distribution cabinet 20 that is divided generally into the three separate, vertically arranged compartments 30, 40, 50 of roughly equal size. In the embodiments depicted herein, the interior of the distribution cabinet 20 is also divided into the horizontally arranged fiber splicing area 60 located generally below the compartments 30, 40, 50. As mentioned previously, the fiber splicing area 60 is optional and may be omitted in the event that both the feeder cable and the distribution cable(s) are pre-connectorized. The coupler module storage compartment 30 preferably projects forward of the rear panel 25 (FIG. 3A) to improve access to the front side of the coupler modules 35 mounted therein. The fiber slack storage compartment 40 is preferably recessed within the distribution cabinet 20 (FIG. 3A, FIG. 3B) such the fiber slack storage hubs 45 mounted therein do not interfere with fiber management between the coupler module storage compartment 30 and the fiber connection compartment 50, or with optical connections the field technician may need to make within the compartment 30 or the compartment 50. The fiber connection compartment 50 preferably projects forward of the rear panel 25 (FIG. 3B) and is angled inwardly relative to the distribution cabinet 20 to improve access to the front side of the fiber connection field 52 and to the connector storage (parking) field 54 mounted therein. The fiber splicing area 60 is preferably located conveniently depth-wise between the rear panel 25 and the front door and laterally between the opposed side panels 21, 22 to provide ready and easy access to the splice drawer 65 and sufficient space to perform necessary splicing operations. The configuration of the distribution cabinet 20 shown herein is desirable to provide easy fiber management, convenient fiber slack storage, bend radius control and ready connector access in a clean, compact enclosure that facilitates handling, installation, initial configuration, reconfiguration and testing. However, the configurations shown in the accompanying drawings are not required except to the extent that the distribution cabinet 20 must comprise at least three vertically arranged compartments disposed laterally within the interior defined by the enclosure of the cabinet that generally provide the corresponding optical fiber functionality described herein with respect to each compartment. Any such configurations comprising compartments having the desired optical fiber functionality positioned in any lateral location relative to one another are intended to be included within the scope of the claimed invention.

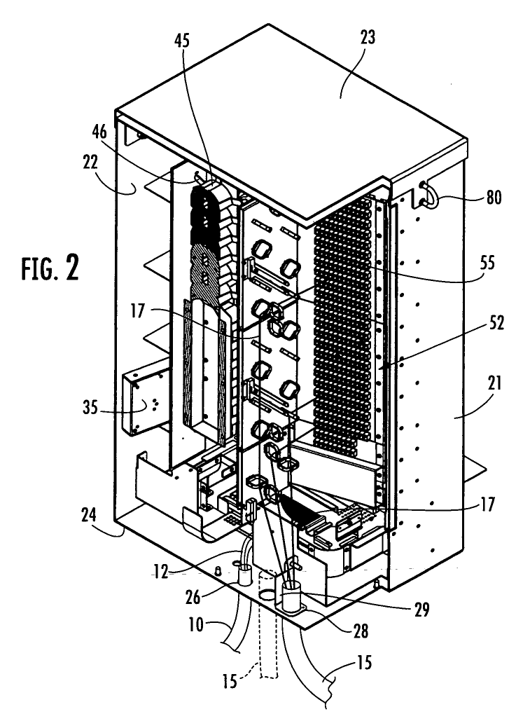

Referring specifically to FIG. 2, a feeder cable 10 of a PON belonging to a provider of a broadband optical communications service enters the distribution cabinet 20 through an opening, or feeder cable port, 26 formed in the bottom panel 24. The location of the feeder cable port 26 is shown for convenience only, and if desired, the feeder cable port 26 may be formed in either of the side panels 21, 22, the top panel 23 or the rear panel 25. Regardless, the feeder cable port 26 is typically sealed around the feeder cable 10 from the external environment by a conventional grommet, gasket, gel or other sealing material (not shown) in a known manner. The feeder cable 10 may comprise any number of optical fibers in any conventional configuration or arrangement, and at least some of the optical fibers may extend uninterrupted within the distribution cabinet 20 (e.g., express fibers) and exit the cabinet through the feeder cable port 26 or another opening formed in the enclosure for use at another optical fiber distribution cabinet (e.g., FDH, FDT) downstream from the distribution cabinet 20. In the embodiments illustrated herein, however, all of the optical fibers 12 of the feeder cable 10 are routed from the rear of the distribution cabinet 20 adjacent the bottom panel 24 into the fiber splicing area 60 disposed medially between the rear panel 25 and the front door. In other embodiments within the scope of the invention not illustrated in the accompanying drawings, all or some of the optical fibers 12 of the feeder cable 10 may be pre-connectorized and routed directly to the coupler modules 35, as will be described. Similarly, one or more distribution cables 15 of the PON enter the distribution cabinet 20 through one or more openings, or distribution cable ports, 28 formed in the bottom panel 24. The location of the distribution cable ports 28 is shown for convenience only, and if desired, the distribution cable ports 28 may be formed in either of the side panels 21, 22, the top panel 23 or the rear panel 25. Regardless, each distribution cable port 26 is typically sealed around the distribution cable 12 from the external environment by a conventional grommet, gasket, gel or other sealing material (not shown) in a known manner, and a conventional strain relief bracket 29 may be provided for securing the outer jacket of each distribution cable 15 to the distribution cabinet 20. The distribution cable 15 may comprise any number of optical fibers 17 in any conventional configuration or arrangement, and at least some of the optical fibers 17 may extend uninterrupted within the distribution cabinet 20 (e.g., express fibers) and exit the cabinet through a distribution cable port 28 or another opening formed in the enclosure. Furthermore, at least some of the optical fibers 17 of the distribution cable 15 initially may not be connected to a subscriber at their downstream ends to expand the PON further for future use, or may be spare optical fibers for anticipated repair operations. In the embodiments illustrated herein, the distribution cable(s) 15 are pre-connectorized and the connectorized ends of the jacketed optical fibers 17 are routed to the rear of the fiber connection field 52 of the fiber connection compartment 50 for a purpose to be described. An example of two such optical fibers 17 being routed to connector adapters 55 on the rear side of the fiber connection field 52 of the fiber connection compartment 50 is shown in FIG. 2.

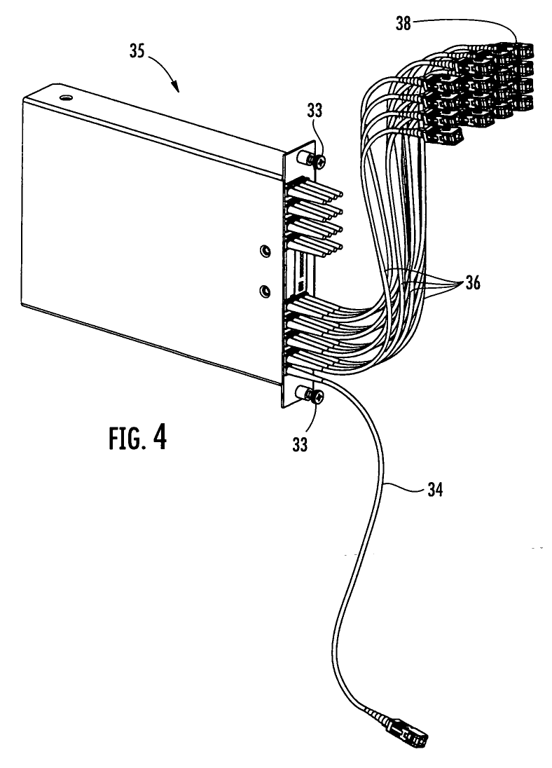

For purposes of example only, the feeder cable 10 as described herein comprises either 9 or 18 useable optical fibers (also referred to herein as feeder cable optical fibers). The distribution cable(s) 15 comprises a total of 288 useable optical fibers (also referred to herein as distribution cable optical fibers). As such, the optical fiber distribution cabinet 20 illustrated in FIGS. 1-5 is a “288-fiber Capacity Fiber Distribution Hub (FDH)” of the type commercially available from Corning Cable Systems LLC of Hickory, N.C. In a particular example, the feeder cable 10 comprises 9 optical fibers and the coupler module storage compartment 30 of the distribution cabinet 20 is configured with 9 corresponding 1×32 optical coupler modules 35 such that the optical signals carried on the 9 feeder cable optical fibers can be split into optical signals carried on up to 288 distribution optical fibers. A typical coupler module 35 is shown in greater detail in FIG. 4. In another particular example, the feeder cable 10 comprises 18 optical fibers and the coupler module storage compartment 30 of the distribution cabinet 20 is configured with 18 corresponding 1×16 optical coupler modules 35 such that the optical signals carried on the 18 feeder cable optical fibers can be split into optical signals carried on up to 288 distribution optical fibers. While the 288-fiber capacity distribution cabinet is common, a distribution cabinet 20 according to the present invention resulting in any convenient number of distribution cable optical fibers is possible, including for example, 144, 432, 576, etc. It will be readily apparent to one of ordinary skill in the art that the distribution cabinet 20 can be easily scaled to interconnect any desired number of feeder cable optical fibers with any desired number of distribution cable optical fibers, given operational size limitations and coupler module constraints.

FIG. 3A shows the coupler module storage compartment 30 and the fiber slack storage compartment 40 in perspective with greater detail. As shown, the coupler module storage compartment 30 is provided with a plurality, and in particular 9, openings 31 formed therein for receiving one or more coupler modules 35. Above and below each opening 31 is a series of three relatively small holes 32 for receiving fasteners 33 (FIG. 4) provided on the coupler modules 35 that secure the coupler module 35 within the opening 31. The center holes in the series of holes 32 are utilized to secure a single 1×32 coupler module 35 within the opening 31, while the lateral outer holes 32 are utilized to secure a pair of 1×18 coupler modules 35 within each opening 31. As best shown in FIG. 1 and FIG. 3A, the coupler module storage compartment 30 illustrated herein is configured to mount up to 9 1×32 coupler modules 35, up to 18 1×16 coupler modules 35, or any combination of 1×32 and 1×16 coupler modules that can be accommodated by the series of holes 32. Each coupler module 35 comprises a coupler module input fiber 34 for being optically connected (e.g., fusion spliced, mechanically spliced or connectorized and interconnected through a suitable fiber optic adapter) to a corresponding feeder cable optical fiber 12. The optical signal carried on the feeder cable optical fiber 12, and hence thereafter carried on the coupler module input fiber 34, is split within the coupler module 35 in a known manner into a plurality of optical signals carried on a corresponding number of coupler module output fibers 36. As shown in FIG. 4, the coupler module input fiber 34 and the coupler module output fibers 36 extending from the coupler module 35 are connectorized. In alternative embodiments, the coupler module 35 may be configured with a suitable fiber optic adapter for receiving a connectorized coupler module input fiber from within the coupler module 35 and a pre-connectorized feeder cable optical fiber 12 from outside the coupler module 35. In the illustrated embodiments, however, the connectorized end of the coupler module input fiber 34 is cut off and the jacketed coupler module input fiber 34 is routed to the fiber splicing area 60 to be spliced to the corresponding feeder cable optical fiber 12. The connectorized coupler module optical fibers 36 are routed to the connector adapters 55 on the front side of the fiber connection field 52 to be interconnected with the distribution cable optical fibers 17, as will be described.

As mentioned previously, in the exemplary preferred embodiments shown and described herein, the feeder cable optical fibers are not pre-connectorized. Therefore, the feeder cable 10 may be pre-installed, strain-relieved and each feeder cable optical fiber 12 routed to the fiber splicing area 60 for splicing in a known manner to a corresponding coupler module input fiber 34 routed from a coupler module 35 within the coupler module storage compartment 30 to the fiber splicing area 60. The manner in which the feeder cable optical fiber 12 and the coupler module input fiber 34 are routed is not critical to the present invention and the fibers 12, 34 may be routed to the fiber splicing area 60 in any suitable manner such that the minimum fiber bend radius is not violated and the optical fibers 12, 34 are not damaged in any way. Referring to the typical 1×32 coupler module 35 shown in FIG. 4, the connectorized end of the single coupler module input fiber 34 is cut off and the coupler module input fiber routed to the fiber splicing area 60, for example in the manner depicted in FIG. 6. Meanwhile, the feeder cable optical fiber 12 is routed from the rear of the distribution cabinet 20 adjacent the bottom panel 24 to the fiber splicing area 60, for example in the manner depicted in FIG. 6. Specifically, the coupler module input fiber 34 is routed over one of the vertically arranged fiber routing guides 70 disposed laterally outwardly of the coupler module storage compartment 30 and around various bend radius guides 62 into a splice drawer 65 disposed within the fiber splicing area 60. The jacketed input fiber 34 is then routed across a strain relief bracket 64 where the jacket is strain relieved to the bracket by a conventional cable tie. Thereafter, the jacket is stripped and a sufficient length of the bare input optical fiber 34 is stored within fiber slack storage guides 66 before being routed around the splice drawer 65 to a splice protector 68 and spliced to the feeder cable optical fiber 12. Likewise, the jacketed feeder cable optical fiber 12 is routed around various bend radius guides 62 into the splice drawer 65 and strain relieved on the strain relief bracket 64 by a conventional cable tie. Thereafter, the jacket is stripped and a sufficient length of the bare feeder cable optical fiber 12 is routed around the splice drawer 65 to the splice protector 68 and splice to the coupler module input fiber 34. The process is repeated for each of the optical fibers 12, 34 to be spliced together until the coupler module input fiber 34 of each coupler module 35 mounted in the coupler module storage compartment 30 is interconnected with an optical fiber 12 of the feeder cable 10 (a total of 9 in the exemplary embodiment utilizing 1×32 coupler modules shown and described herein).

As mentioned previously and depicted in FIG. 2, the distribution cable optical fibers 17 are routed from the rear of the distribution cabinet 20 adjacent the bottom panel 24 to the rear of the fiber connection compartment 50, and specifically, to the rear of the connector adapters 55 disposed on the connection field 52 of the fiber connection compartment 50. Meanwhile, the connectorized coupler module output fibers 36 are routed to front of the corresponding connector adapters 55 disposed on the connection field 52 of the fiber connection compartment 50 to be interconnected with the distribution cable optical fibers 17 routed to the rear of the connector adapters 55. In the event that both the feeder cable 10 and the distribution cable(s) 15 are pre-connectorized, the fiber connection field 52 may comprise a distribution termination field (also referred to herein as the output fiber termination field) 51 for interconnecting the coupler module output fibers 36 with the distribution cable optical fibers 17, and a feeder termination field (also referred to herein as the input fiber termination field) 53 for interconnecting the connectorized coupler module input fibers 36 as shown in FIG. 4) with the feeder cable optical fibers 12. As will be readily understood by those of skill in art, the fiber splicing area 60 is unnecessary when both the feeder cable 10 and the distribution cable(s) 15 are pre-connectorized, and therefore, may be omitted in order to further reduce the overall volume of the distribution cabinet 20. This option may be preferred for obvious reasons when the distribution cabinet 20 is mounted to a telephone pole (i.e., pole-mounted) instead of mounted on the ground on a concrete pad (i.e., pad-mounted). Although not illustrated herein, each coupler module 35 may be provided with an input fiber connector adapter and a plurality of output fiber connector adapters, and the coupler module input fiber 34 and the coupler module output fibers 36 may be connectorized on both ends (i.e., fiber optic jumper cables, or “jumpers”). In this embodiment, the jumper 34 may be routed between the coupler module 35 and the input fiber (feeder) termination field 53, while the jumpers 36 are routed between the coupler module 35 and the output fiber (distribution) termination field 51. Naturally, even if only the distribution cable(s) 15 are pre-connectorized, the coupler module output fibers 36 may be jumpers (as opposed to pigtails) and routed as described above, while the coupler module input fiber 34 is spliced directly to the corresponding feeder cable optical fiber 12 in the fiber splicing area 60 and the input fiber (feeder) termination field 53 remains unused, or even omitted altogether from the distribution cabinet 20.

As described immediately above, the fiber connection field 52 may comprise a distribution (output fiber) termination field 51 and a feeder (input fiber) termination field 53. As shown, the distribution termination field 51 is disposed vertically above the feeder termination field 53. However, the position of the feeder termination field 53 and the distribution termination field 51 may be interchanged, or the feeder termination field 53 may be interposed within the distribution termination field 51. As shown in the exemplary embodiments provided herein, the distribution termination field 51 is configured to receive up to 288 connector adapters 55 and the feeder termination field 53 is configured to receive up to 18 connector adapters 55. As mentioned previously, the connector adapters 55 interconnect the distribution cable optical fibers 17 with the coupler module output fibers 36, and if the feeder cable 10 is pre-connectorized, interconnect the feeder cable optical fibers 12 with the coupler module input fibers 34. In the embodiments illustrated herein, there can be up to 18 feeder cable input fibers 12 interconnected with coupler module input fibers 34, and up to 288 distribution cable optical fibers 17 interconnected with coupler module output fibers 36 in a fully-populated optical fiber distribution cabinet 20. As shown, the fiber connection compartment 50 further comprises a connector storage (parking) field 54 for storing the connectors 38 (FIG. 4) of any connectorized coupler module input fibers 34 and/or coupler module output fibers 36 that are routed between the coupler module storage compartment 30 and the fiber connection compartment 50, but are not being used. The unused connectors 38 may be spares, or may be the extra coupler module output fibers 36 from a fully-populated coupler module 35 that are not presently needed to be interconnected with available distribution cable optical fibers 17. As shown, the connector storage field 54 is disposed vertically beneath the feeder termination field 53, but may be disposed above the distribution termination field 53 or between the distribution termination field 51 and the feeder termination field 53, as desired. Furthermore, the connector storage field 54 is configured to store up to 4 rows of 18 connectors 38, but may be configured in any desired manner.

A particular advantage of the distribution cabinet 20 is the manner in which the coupler module output fibers 36 and the coupler module input fibers 34 (if connectorized and routed to the feeder termination field 53 instead of being routed to the fiber splicing area 60 and spliced directly to the feeder cable optical fibers 12) are routed between the coupler module storage compartment 30 and the fiber connection compartment 50. Advantageously, the coupler modules 35 incorporate uniform (i.e., single) length pigtails or jumpers 34, 36 in order to reduce manufacturing costs and ensure compatibility. Accordingly, any coupler module 35 may be positioned within any of the openings 31 provided in the coupler module storage compartment 30 and the pigtails or jumpers 34, 36 may be routed to any of the connector adapters 55 at any position on the distribution termination field 51 or the feeder termination field 51 within the fiber connection compartment 60. In particular, the pigtail or jumper 34, 36 is routed away from the corresponding coupler module 35 and over one of the conveniently located fiber routing guides 70 disposed laterally outwardly of the coupler module storage compartment 30. It should be noted that the fiber routing guides 70 are configured to ensure the minimum bend radius of the optical fiber is not violated as the pigtail or jumper 34, 36 is routed both horizontally and vertically over the fiber routing guide 70. As best seen in FIG. 6, each fiber routing guide 70 comprises a horizontal bend radius surface 71 and a vertical bend radius surface 73 for that purpose. As best seen in FIG. 3A, the pigtail or jumper 34, 36 is then routed over or around various bend radius guides 62 between the coupler module storage compartment 30 and the fiber slack storage compartment 40. At this point, the connector 38 mounted on the opposite end of the pigtail or jumper 34, 36 is secured to the appropriate connector adapter 55 in the distribution termination field 51 or the feeder termination field 53, or to the connector storage field 54. The opposite end of the pigtail or jumper 34, 36 is then routed backwards from the connector adapter 55 or the connector storage field 54 over one of the conveniently located fiber routing guides 70 disposed laterally outwardly of the fiber connection compartment 50. As best seen in FIG. 3B, the pigtail or jumper 34, 36 is then routed over or around various bend radius guides 62 between the fiber connection compartment 50 and the fiber slack storage compartment 40. As best seen in FIG. 1, the remaining slack length of the uniform (single) length pigtail or jumper 34, 36 is finally draped in a fairly loose manner over the vertically highest fiber slack storage hub 45 that is reachable within the fiber slack storage compartment 40. Each fiber slack storage hub 45 includes at least one, and preferably, a plurality of retaining flanges 46 depending outwardly from the bend radius control surface for retaining the pigtail or jumper 34, 36 on the fiber slack storage hub 45.

FIG. 6 shows another exemplary embodiment of an optical fiber distribution cabinet 120 arranged and configured in accordance with the present invention. The distribution cabinet 120 comprises at least one, and preferably two, openable front doors (shown removed for purposes of clarity) that provide access to a distribution cabinet 20 of the type described above located within the interior of the cabinet 120 on the left-hand side and a distribution cabinet 20a located within the interior of cabinet 120 on the right-hand side. The distribution cabinet 20a comprises the vertically arranged and laterally disposed coupler module storage compartment 30, fiber slack storage compartment 40 and fiber connection compartment 50 previously described, but is configured opposite (i.e., mirror image) to the distribution cabinet 20. As such, the coupler module storage compartments 30 are located adjacent one another laterally inwardly relative to the cabinet 120 and the fiber connection compartments 50 are located opposite one another laterally outwardly relative to the cabinet 120. As shown, the cabinet 120 comprises only a single fiber splicing area 60 disposed within the distribution cabinet 20, which is configured with a sufficient number of splice drawers 65 to splice the feeder cable optical fibers 12 of both feeder cables 10 to the coupler module input fibers 34 of both distribution cabinets 20, 20a. Accordingly, the cabinet 120, as shown in FIG. 6 and described herein, is configured to interconnect up to 36 feeder cable optical fibers 12 with up to 576 distribution cable optical fibers 17. Therefore, the cabinet 120 is a 576-fiber Capacity Fiber Distribution Hub (FDH) of the type commercially available from Corning Cable Systems LLC of Hickory, N.C. The cabinet 120 may further comprise hoists 80 for lifting the cabinet, for example with a crane, in order to place the cabinet on a concrete pad (i.e., pad-mounting) or to support the cabinet while being secured to a telephone pole (i.e., pole-mounting). The hoists 80 may also function as safety hooks for securing the safety harness of a field technician while performing installation, configuration, reconfiguration or repair operations on a cabinet 120 (or the distribution cabinet 20 previously described) secured to a telephone pole.

It will be immediately apparent to those skilled in the art that modifications and variations can be made to the present invention without departing from the intended spirit and scope of the invention. Thus, it is intended that the present invention cover all conceivable modifications and variations of the invention described herein and shown in the accompanying drawings, provided those alternative embodiments come within the scope of the appended claims and their equivalents.

That which is claimed is:

1. An optical fiber distribution cabinet comprising:
an enclosure defining an interior;
a first compartment vertically arranged within the interior and comprising at least one coupler module for splitting at least one input optical signal into a plurality of output optical signals;
a second compartment vertically arranged within the interior and disposed laterally adjacent the first compartment, the second compartment comprising at least one fiber slack storage hub;
a third compartment vertically arranged within the interior and disposed laterally adjacent the second compartment, the third compartment comprising a fiber connection field;
at least one optical fiber cable extending between the coupler module within the first compartment and the fiber connection field within the third compartment.

2. An optical fiber distribution cabinet according to claim 1 wherein the optical fiber cable is routed through the second compartment over the fiber slack storage hub.

3. An optical fiber distribution cabinet according to claim 1 wherein the fiber connection field comprises an input fiber termination field and an output fiber termination field.

4. An optical fiber distribution cabinet according to claim 3 wherein the output fiber termination field is disposed vertically above the input fiber termination field.

5. An optical fiber distribution cabinet according to claim 1 wherein the optical fiber cable is a pigtail comprising a first end in optical communication with the coupler module and a second end having a fiber optic connector mounted thereon and wherein the pigtail is routed from the coupler module to a connector adapter disposed on the fiber connection field.

6. An optical fiber distribution cabinet according to claim 1:
wherein the optical fiber cable is a jumper comprising a first end having a first fiber optic connector mounted thereon and a second end having a second fiber optic connector mounted thereon;
wherein the coupler module has a first connector adapter disposed thereon for receiving the first fiber optic connector;
wherein the fiber connection field has a second connector adapter disposed thereon for receiving the second fiber optic connector; and
wherein the jumper is routed from the first connector adapter disposed on the coupler module to the second connector adapter disposed on the fiber connection field.

7. An optical fiber distribution cabinet according to claim 1 further comprising a fiber splicing area disposed vertically beneath at least the third compartment, the fiber splicing area for splicing an optical fiber of a feeder cable to an input fiber of the coupler module.

8. An optical fiber distribution cabinet according to claim 7 wherein the optical fiber cable is a pigtail comprising a first end in optical communication with the coupler module and a second end having a fiber optic connector mounted thereon that is routed from the coupler module to the fiber connection field.

9. An optical fiber distribution cabinet according to claim 7:
wherein the optical fiber cable is a jumper comprising a first end having a first fiber optic connector mounted thereon and a second end having a second fiber optic connector mounted thereon;
wherein the coupler module has a first connector adapter disposed thereon for receiving the first fiber optic connector;
wherein the fiber connection field has a second connector adapter disposed thereon for receiving the second fiber optic connector; and
wherein the jumper is routed from the first connector adapter disposed on the coupler module to the second connector adapter disposed on the fiber connection field.

10. An optical fiber distribution cabinet according to claim 1, wherein the third compartment further comprises a connector storage field disposed vertically beneath the fiber connection field.

11. An optical fiber distribution cabinet according to claim 1, wherein the at least one coupler module comprises a plurality of coupler modules and wherein each coupler module comprises at least one input fiber and a plurality of output fibers.

12. An optical fiber distribution cabinet according to claim 1:
wherein the at least one optical fiber cable comprises at least one input fiber jumper and a plurality of output fiber jumpers;
wherein the input fiber jumper and each of the output fiber jumpers comprises a first fiber optic connector mounted on an end thereof and a second fiber optic connector mounted on the other end thereof;
wherein the at least one coupler module has a plurality of first connector adapters disposed thereon and wherein the fiber connection field has a plurality of second connector adapters disposed thereon; and
wherein the input fiber jumper and at least some of the output fiber jumpers are routed from corresponding first connector adapters disposed on the coupler module to corresponding second connector adapters disposed on the fiber connection field.

13. An optical fiber distribution cabinet for interconnecting an optical fiber of a feeder cable with a plurality of optical fibers of at least one distribution cable, the distribution cabinet comprising:
an enclosure defining an interior;
a coupler module storage compartment vertically arranged within the interior and comprising at least one coupler module for splitting an optical signal carried on the optical fiber of the feeder cable into a plurality of optical signals carried on the optical fibers of the distribution cable;
a fiber slack storage compartment vertically arranged within the interior and disposed laterally adjacent the coupler module storage compartment, the fiber slack storage compartment comprising at least one fiber slack storage hub;
a fiber connection compartment vertically arranged within the interior and disposed laterally adjacent the fiber slack storage compartment, the fiber connection compartment comprising a fiber connection field;
at least one optical fiber cable extending between the coupler module and the fiber connection field.

14. An optical fiber distribution cabinet according to claim 13 wherein the optical fiber cable is routed through the fiber slack storage compartment and a slack length of the optical fiber cable is retained on the fiber slack storage hub.

15. An optical fiber distribution cabinet according to claim 13 wherein the fiber connection field comprises a feeder termination field and a distribution termination field.

16. An optical fiber distribution cabinet according to claim 15 wherein the distribution termination field is disposed vertically above the feeder termination field.

17. An optical fiber distribution cabinet according to claim 13 wherein the optical fiber cable is a pigtail comprising a first end in optical communication with the coupler module and a second end having a fiber optic connector mounted thereon and wherein the pigtail is routed from the coupler module to a connector adapter disposed on the fiber connection field.

18. An optical fiber distribution cabinet according to claim 13:
wherein the optical fiber cable is a jumper comprising a first end having a first fiber optic connector mounted thereon and a second end having a second fiber optic connector mounted thereon;
wherein the coupler module has a first connector adapter disposed thereon for receiving the first fiber optic connector;
wherein the fiber connection field has a second connector adapter disposed thereon for receiving the second fiber optic connector; and
wherein the jumper is routed from the first connector adapter disposed on the coupler module to the second connector adapter disposed on the fiber connection field.

19. An optical fiber distribution cabinet according to claim 13 further comprising a fiber splicing area disposed vertically beneath at least the fiber connection compartment, the fiber splicing area for splicing the optical fiber of the feeder cable to an input fiber of the coupler module.

20. An optical fiber distribution cabinet according to claim 13, wherein the fiber connection compartment further comprises a connector storage field disposed vertically beneath the fiber connection field.
